(19) United States
(12) Patent Application Publication
(10) Pub. No.: US 2009/0285685 A1
(43) Pub. Date: Nov. 19, 2009

(54) Migler's vertical axis wind turbine with energy storage and retrieval means, and with yoke means, and with a rear sail projection arm, and with separated sail restraints, and with a motorized gust and high wind-speed protection system

(76) Inventor: Bernard Migler, Cherry Hill, NJ (US)

Correspondence Address: BERNARD MIGLER, 1405 AUTUMN LANE, CHERRY HILL, NJ, 08003-3014, US

(21) Appl. No.: 12/384,783

(22) Filed: Apr. 9, 2009

Related U.S. Application Data
(60) Provisional application No. 61/127,940, filed on May 16, 2008.

(51) Int. Cl. F03D 3/00; F03B 17/02; F03D 9/00

(52) U.S. Cl. 416/119; 416/132 B; 60/495; 290/55

(57) ABSTRACT

This disclosure presents a means to store and retrieve energy that has been produced by Migler's vertical axis wind turbine, by pulling down a float in water and holding it, thereby storing energy and releasing the float when desired, thereby retrieving the stored energy,. Additionally, the disclosure presents an alternative means of striking the sail restraints of Migler's wind turbine, using a rear projection arm. Additionally, the disclosure presents an alternative yoke for the sails of Migler's wind turbine, as compared to a yoke Migler disclosed earlier. Additionally, the disclosure demonstrates a means to separate the sail restraints on a horizontal arm of Migler's wind turbine, thereby saving cost. Additionally, the disclosure presents motorized means to raise the flapper of the sail restraints of Migler's vertical axis wind turbine. The flappers may be raised in advance of a storm or high wind. Additionally, the disclosure presents a gust detector, consisting of a pair of contacts that make contact during a wind gust. A signal from the contact closure of the gust detector may be used to raise the flappers of Migler's wind turbine to protect the windmill from wind damage.

### CROSS REFERENCE TO RELATED APPLICATIONS

U.S. Pat. No. 6,926,491 B2 (B. Migler)

U.S. Pat. No. 7,334,994 B2 (B. Migler)

U.S. Nonprovisional patent applications Ser. No. 12/002,963

I claim the benefit of:

U.S. Provisional Patent Applications: No. 61/127,940

### STATEMENT REGARDING FEDERALLY SPONSORED RESEARCH OR DEVELOPMENT

There are no rights to this invention made under federally sponsored research or development.

### FIELD OF THE INVENTION

The device relates generally to the field of wind turbines (or windmills) for the production of electricity. More specifically the device relates to Migler's vertical axis wind turbine. More specifically the device relates to Migler's vertical axis wind turbine with yoked sails. More specifically the device relates to means to store and retrieve energy produced by Migler's vertical axis wind turbine.

### BACKGROUND OF THE INVENTION

Energy Storage and Retrieval Means for Migler's Vertical Axis Wind Turbing (FIG. 1 to 3)

Wind blows intermittently, and the energy produced by wind turbines such as Migler's vertical axis wind turbine, (U.S. Pat. No. 6,926,491 B2 hereby incorporated by reference) is generally produced and sent to the electric grid only when the wind is blowing. However, the periods of greatest energy use by consumers may not coincide with the period of greatest energy production by wind turbines. It would be useful if the energy could be stored and released when demand is greatest. It would also be useful if the energy could be stored and released when there is no wind blowing. It would also be useful if the moment to moment variation in wind speed and the corresponding variation in energy produced by wind turbines could be reduced or smoothed out over time. Finally, it would also be useful if the device could store and retrieve energy produced by multiple wind turbines or other sources of energy. The invention disclosed here produces these desired effects.

Rear Projection Arm of a Sail Frame (FIG. 4)

In Migler's vertical axis wind turbine the sail frames impact the sail restraint arms to provide energy for rotation of the wind turbine. Alternatively, a rear projection arm from each sail frame is able to produce the same effect. In addition, since the rear projection arm and the adjustable sail restraints operate on the side opposite the sail frame, there is a more balanced arrangement of weight on the horizontal arms of the device.

An Alternate Yoke for Migler's Vertical Axis Wind Turbine (FIG. 5)

In Migler's vertical axis wind turbine adjacent sail frames may be yoked by a yoke secured to extensions of adjacent masts, as disclosed in U.S. Nonprovisional patent application Ser. No. 12/002,963 hereby incorporated by reference. The device disclosed here provides an alternate means of yoking two adjacent sail frames, that is, by connecting two adjacent sail frames with a yoke, rather than connecting extensions of the masts with a yoke.

Seperated Sail Restraints. (FIG. 6)

In Migler's vertical axis wind turbine each sail frame is associated with a pair of adjustable sail restraints, that is, an inner and an outer sail restraint. When yoked sails are used, as in U.S. Nonprovisional patent application Ser. No. 12/002,963, the adjustable sail restraints may be separated, so that the inner adjustable sail restraint is associated with one sail frame and the outer adjustable sail restraint is associated with the other sail.

Gust Detector (FIG. 8)

When a gust of high wind-speed occurs a pair of contacts is closed briefly. The detection of a gust of wind by this means can then be used by the device. For example, the sail restraints on all sails can be adjusted to feather all the sails for a period of time to protect the windmill.

Motorized Gust Protection System (FIG. 9 to 11)

Strong, steady wind or occasional gusts are liable to damage any wind turbine. Means of protecting Migler's vertical axis wind turbine from strong winds and gusts are desirable. Accordingly, a gust detector and motorized sail restraint withdrawal system are disclosed here. The gust detector and motorized sail restraint withdrawal system are improvements to Migler's U.S. Pat. No. 7,334,994 B2 (hereby incorporated by reference) “Automatic self-feathering and resetting sail restraints for Migler's vertical axis wind turbine.”

### BRIEF SUMMARY OF THE INVENTION

1) Regarding the energy storage and retrieval device disclosed here, there is a need for a simple means of storing and retrieving the energy produced by a Migler vertical axis wind turbine. In the device disclosed here, silos on farms (or similar structures) are converted into water storage tanks and used to store the energy of Migler's vertical axis wind turbine for release at another time.

The energy is stored by drawing a float down into water (a water tank or any body of water) and releasing it under controlled conditions. The energy can be released into the electrical grid at optimal times, for example during nighttime when electric cars are being charged, or during hot weather when air conditioners are being used, or when there is no wind blowing.

In addition, the device can store energy from very low wind-speed blowing over a long period of time, and release the stored energy over a short period of time at a desirable energy level for the electric grid.

2) Regarding the rear sail frame projection arm disclosed here, the current design of Migler's vertical axis wind turbine places excessive weight on one side of the horizontal arms. The rear sail frame projection arm which impacts the sail restraints from the side opposite the sail, contributes to a more balanced distribution of weights on the two sides of a horizontal arm.

3) Regarding the alternate yoke means disclosed here, the yoke is secured to the frames of adjacent sails, providing simpler construction than yokes secured to extensions of the masts.

4) Regarding the separation of the adjustable sail restraints, when the sail frames of Migler's vertical axis wind turbine are yoked, the adjustable sail restraints may be separated, so that the inner adjustable sail restraint is impacted by one sail frame and the outer adjustable sail restraint is impacted by another sail frame.

5) Regarding the issue of protecting the windmill from wind damage, Migler's 2008 patent disclosed an alternative sail restraint from the one disclosed in his 2005 patent, the newer sail restraints being self-feathering and resetting. While his 2005 patent disclosed motorized means of removing the sail restraint from the path of the sail frame, the 2008 patent did not. Here, means of accomplishing this is disclosed. In addition, a gust detector is described for detecting the occurrence of a wind gust sufficient to allow a sail frame to pass by a sail restraint. The combination of the gust detector and the motorized means of removing the sail restraint from the path of the sail frame allows the creation of a gust protection system in which the occurrence of a gust triggers the gust detector which then triggers the motorized withdrawal (pulling up) of the sail restraint (or of all the sail restraints) from the path of the sail frames for a period of time. In addition, when gusts of wind or very high wind-speeds are anticipated by weather reports, the sail restraints can be raised in advance.

### BRIEF DESCRIPTION OF THE DRAWINGS

The inventions are not intended to be limited to the precise arrangements and instrumentalities shown.

FIG. 1 identified as prior art in the figure, is a three dimensional view of Migler's vertical axis wind turbine, as disclosed in U.S. Pat. No. 6,926,491 B2, hereby incorporated by reference. The dynamo/generator 15 of the wind turbine produces electricity when wind rotates the windmill.

FIG. 2 is a mid-sectional view through an energy storage and retrieval device that is powered by the dynamo of Migler's vertical axis wind turbine. It has a dynamo/motor a brake, and a transmission that engages an axel, which controls a float in a water tank, both during energy storage and retrieval.

FIG. 3 is a mid-sectional view through an energy storage and retrieval device that is powered by Migler's vertical axis wind turbine. It has a motor, a brake and a transmission that are engaged during energy storage, and a separate dynamo and transmission that are engaged during energy retrieval.

FIG. 4 is a three dimensional view of one horizontal arm of Migler's vertical axis wind turbine showing a sail frame with a rear projecting arm.

FIG. 5 is a three dimensional view of one arm of Migler's vertical axis wind turbine in which two sails are yoked by a yoke that is secured to the frames of adjacent sails.

FIG. 6 is a three dimensional view of one horizontal arm of Migler's vertical axis wind turbine, showing two adjacent yoked sails in which the adjustable sail restraints are separated, with an inner adjustable sail restraint restraining one sail (as shown in the figure) and an adjustable outer sail restraint that restrains another sail.

FIG. 7, identified as prior art in the figure, is a side view of an automatic self-feathering and resetting sail restraint for Migler's vertical axis wind turbine, as disclosed in U.S. Pat. No. 7,334,994 B2, hereby incorporated by reference.

FIG. 8, is a side view of an automatic self-feathering and resetting sail restraint having a “gust” detector. A gust of wind that passes by the sail restraint causes the contacts of the gust detector to make contact.

FIG. 9 identified as prior art in the figure shows means to raise a sail restraint arm by a pulley and cable.

FIG. 10 is a side view of an automatic self-feathering and resetting sail restraint, of the kind shown in FIG. 9 above, having a motor connected to the cable. Operation of the motor draws in the cable raising the sail restraint. The motor may be operated to hold the sail restraints in the withdrawn position in anticipation of strong winds.

FIG. 11, is a side view of an automatic self-feathering and resetting sail restraint for Migler's vertical axis wind turbine, of the kind shown in FIG. 9 above, having both motorized sail restraint withdrawal means and gust detector means. The “gust” detector is connected electrically to the motor (not shown.) When a “gust” is detected, one or all the sail restraints may pulled up by their motors and held in the pulled up position for a limited period of time in anticipation of additional wind gusts or very high wind-speeds.

### DETAILED DESCRIPTION OF THE DRAWINGS

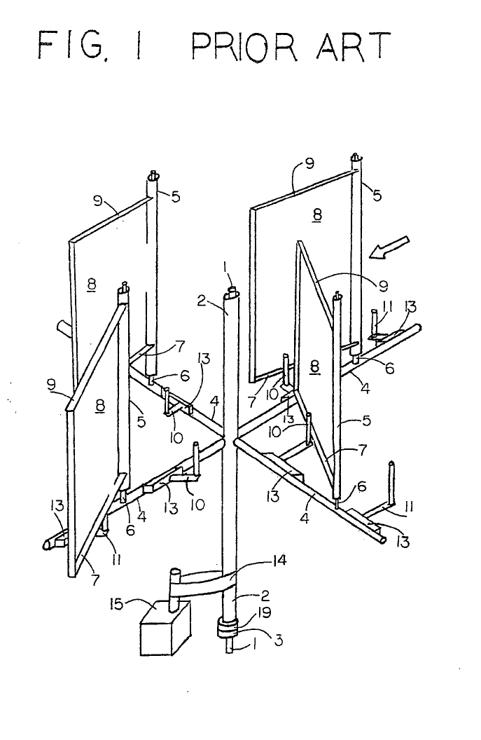

1) Referring now to the drawing in FIG. 1 there is shown a three dimensional drawing of Migler's vertical axis wind turbine as prior art. The reader is referred to U.S. Pat. No. 6,926,491B2 for a complete description of the device and its operation. For the purpose of the present inventions, note in particular that wind causes the rotation of the tower collar 2 around the tower 1. The tower collar 2 causes rotation of the driving belt 14 to operate the dynamo/generator 15, producing electricity.

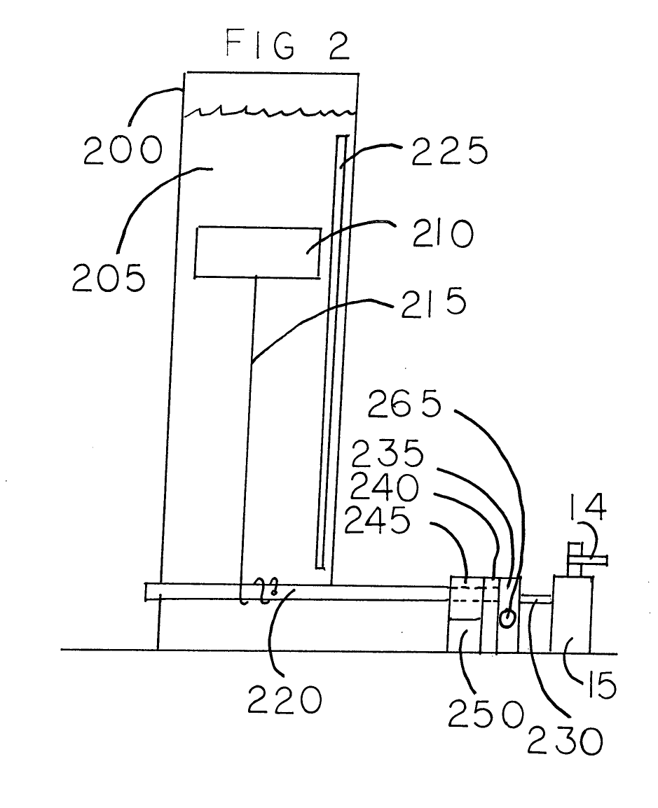

2) Referring now to the drawing in FIG. 2 there is shown a cross-sectional view through the middle of an energy storage and retrieval device for Migler's vertical axis wind turbine. A water storage tank 200 is filled with water. Said water storage tank 200 may be a farmer's silo strengthened to hold water, or any similar structure able to hold water. (The water may be in a tank or in any body of water.) The water may be fresh water or seawater. A float 210 is secured by a cable 215 wound around an axel 220 at the base of the water storage tank 200. The vertical location of the float 210 is detected by a float position sensor 225, using conventional technology. When the wind is blowing, causing rotation of the tower collar 2 and drive belt 14 of Migler's vertical axis wind turbine the dynamo/generator 15 produces electricity. The electricity produced by the dynamo/generator 15 is sent by a primary input connection 230 to a controller 235. An adjustable brake 240 for said axel 220 is operated by said controller 235 so that the brake is either fully on, fully off, or partially on. A motor/dynamo 250 functions as a motor when electricity is applied to it by the controller 235. When electricity is applied to the motor/dynamo 250 and the brake 240 is released, the motor/dynamo 250 rotates a transmission 245 which rotates the axel 220 at low speed, pulling down the float 210. When the float 210 has been pulled down, the brake 240 is applied storing the energy of the wind for later release.

When energy has been stored the energy may be retrieved by the release, or partial release of the brake 240 by the controller 235, so that the float 210 is allowed to rise.

When the float 210 rises it rotates the axel 220, which in turn rotates the transmission 245 at high speed. When the transmission 245 rotates at high speed it drives the motor/dynamo 250 at high speed causing the production of electricity which is available at the secondary power output connection 265. The rate at which the float 210 is allowed to rise is controlled by the controller 235 adjusting the brake 240. so that when the float 210 is near the bottom of the storage tank the float rises slowly, but more rapidly as the float rises. This action smoothes the power output during release of stored energy, and contributes to the solution of the problem of variable electrical power output of the device as the speed of the wind varies.

The controller 235 uses conventional circuitry and follows a program based on information from the float position sensor 225 and from the presence or absence wind as determined by the presence or absence of electricity from the dynamo/generator 15 of Migler's vertical axis wind turbine.

The program of the controller 235 follows the following rules:

Rule #1) When there is wind (as indicated by electrical input from the generator/dynamo 15) and the float 210 is at the top of the water storage tank 200 (that is, no energy has been stored) as indicated by the float position sensor 225 the brake 235 on the axel 220 is released, the motor/dynamo 250 is engaged and operates the transmission 245 which rotates the axel 220 to pull down the float 210 until the float-position sensor 225 indicates that the float 210 is at the bottom of the water storage tank 200 and energy has been stored for later release.

Rule #2) When there is wind (as indicated by electrical input from the generator/dynamo 15) and the float 210 is at the bottom of the water storage tank 200, as indicated by the float position sensor 225 (that is, the maximum amount of energy has been stored, and no more can be stored) the brake 240 on the axel 220 is engaged, the motor/dynamo 250 is disengaged, and electricity from the generator/dynamo 15 is routed by the controller 235 to the primary electricity output connection 265.

Rule #3) When there is wind (as indicated by electrical input from the generator/dynamo 15) and the float 210 is in an intermediate position as indicated by the float position sensor 225, the program follows Rule #1.

Rule #4) When there is no wind (as indicated by the absence of electrical input from the generator/dynamo 15) and the float 210 is at the top of the water storage tank 200 as indicated by the float position sensor 225 (indicating that no energy has been stored) no action is taken.

Rule #5) When there is no wind (as indicated by the absence of electrical input from the generator/dynamo 15) and the float 210 is at the bottom of the water storage tank or in an intermediate position, as indicated by the float position sensor 225 (indicating that energy has been stored) the brake 240 is partially released, allowing the float 210 to begin to rise. When the float 210 begins to rise it causes the transmission 245 to rotate at high speed which turns the motor/dynamo 250 at high speed, producing electricity. The controller 235 routes the electricity to the primary electricity output connection 265.

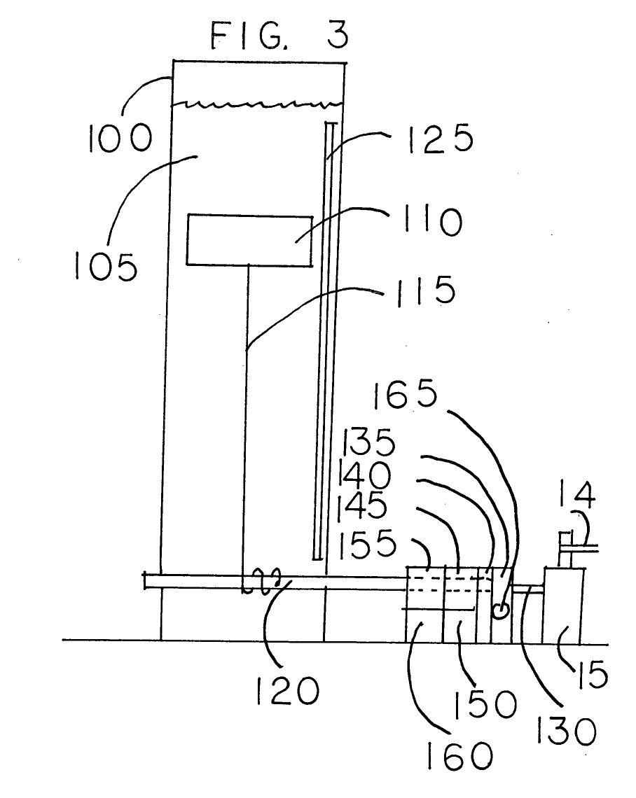

Referring now to the drawing in FIG. 3, there is shown a cross sectional view through the middle of another embodiment of an energy storage and retrieval device for Migler's vertical axis wind turbine. A water storage tank 100 is filled with water. The water storage tank 100 may be a farmer's silo strengthened to hold water, or any similar structure able to hold water. (The water may be in a tank or in any body of water.) A float 110 is secured by a cable 115 wound around an axel 120 at the base of the water storage tank 100. The vertical position of the float 110 is detected by a float position sensor 125, using conventional technology. When the wind is blowing, causing rotation of the tower collar (not shown) and drive belt 14 of Migler's vertical axis wind turbine the dynamo/generator 15 produces electricity. The electricity produced by the dynamo/generator 15 is sent by a primary input connection 130 to a controller 135. An adjustable brake 140 for the axel 120 is adjusted by the controller 135 so that the brake is fully on, fully off, or partially on. The controller 135 is able to turn a motor 150 on or off. When the motor 150 is turned on, and the brake 140 is turned off, the motor 150 turns a dedicated transmission referred to as a “storge-transmission” transmission 145, which turns said axel 120 at low speed, which pulls said float 110 down into the water. This operation stores the energy produced by Migler's vertical axis wind turbine. When the stored energy is to be released, the brake 140 is partially turned off allowing the float 110 to rise. When the float 110 rises it causes a dedicated transmission referred to as a “release-transmission” 155 to rotate at high speed, which causes a dynamo 160 to rotate at high speed, which produces electricity, which is released through an electricity output connection 165. The rate at which the float 110 is allowed to rise is controlled by the controller 135 adjusting the brake 140 so that when the float 110 is near the bottom of the storage tank 100 the float rises slowly, but more rapidly as the float rises. This action smoothes the power output during release of stored energy.

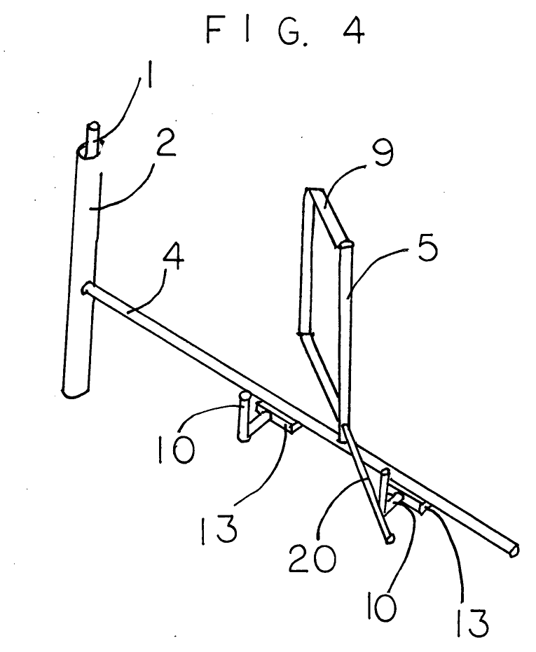

Referring now to the drawing in FIG. 4, there is shown a fragment of Migler's vertical axis wind turbine as shown in FIG. 1, showing only one horizontal arm 4 of Migler's vertical axis wind turbine. FIG. 4 shows the tower 1, tower collar 2 and a single sail frame 9 secured to a rotating mast collar 5. A rear projection arm 20 is secured to the rotating mast collar 5. The rear projection arm 20 is of sufficient length to strike the inner adjustable sail restraint 10 or the outer adjustable sail restraint 10.

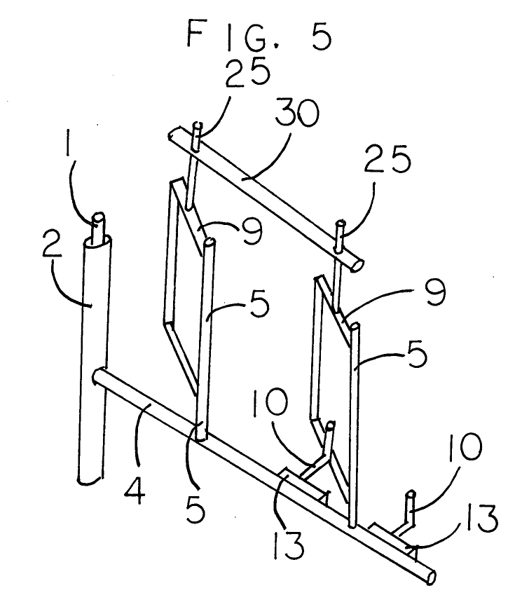

Referring now to the drawing in FIG. 5, there is shown a fragment of Migler's vertical axis wind turbine as shown in FIG. 1, showing the tower 1, the rotating tower collar 2, a horizontal arm 4 secured to said tower collar 2, and inner and outer adjustable sail restraints 10. FIG. 5 shows two rotating masts 5 secured to said horizontal arm 4, with their sail frames 9 secured to said rotating masts 5. A yoke 30 is secured to said sail frames 9 by yoke supports 25. With this arrangement both sails and sail frames can move simultaneously, adding power to the device, and preventing said sail frames 9 from colliding with each other.

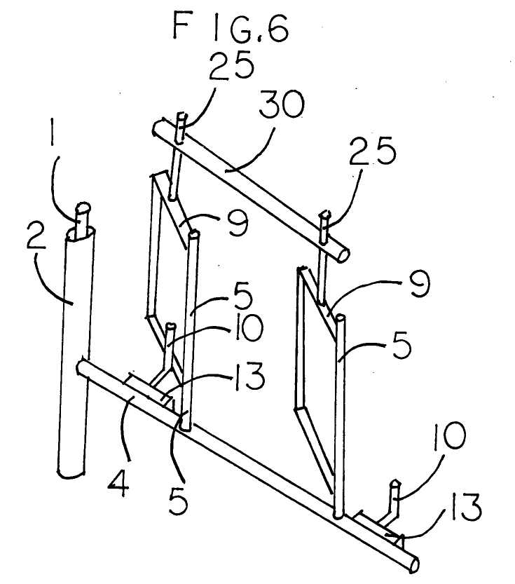

Referring now to the drawing in FIG. 6, there is shown another embodiment of the device shown in FIG. 5. In FIG. 6 the adjustable sail restraints 10 are separated along the horizontal arm 4, such that one adjustable sail restraint is able to restrain the movement of one sail frame, while the other adjustable sail restraint is able to restraint another sail frame.

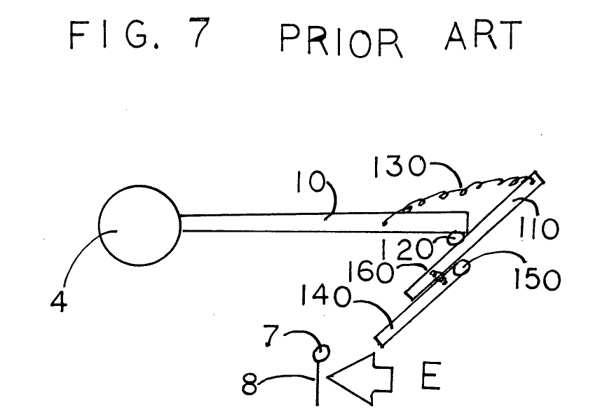

Referring now to FIG. 7, there is shown a drawing of a sail restraint device labeled “prior art.” The reader is referred to U.S. Pat. No. 7,334,994 B2 (B. Migler) hereby incorporated by reference. for a complete description of the device and its operation. Note that FIG. 7 is intended to show a sail 8 and a fragment of its sail frame 7 passing by the sail restraint device due to a strong gust of wind from the direction indicated by the letter “E.”

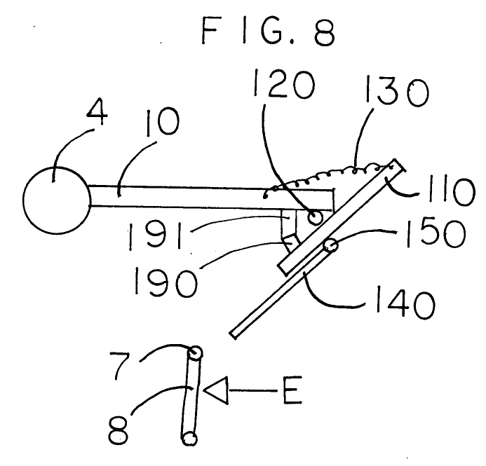

Referring now to the drawing in FIG. 8 there is shown another embodiment of the device shown in FIG. 7. FIG. 8 shows a cross section through the horizontal arm 4 of Migler's vertical axis wind turbine. The figure also shows a horizontal arm of the sail restraint 10, a main vertical member 110, a main rotatable joint 120, a main expansion spring 130, a flapper 140 and a rotatable joint 150. These components are shown in the device in FIG. 7. In addition, the device shown in FIG. 8 has a gust detector which consists of a first contact element 191 secured to said horizontal arm 10 of said sail restraint, and a second contact element 190 secured to said main vertical member 110. Note that FIG. 8 is intended to show a sail 8 and a fragment of its sail frame 7 passing by said sail restraint device due to a strong gust of wind from the direction indicated by the letter “E” and causing said first contact element 191 to contact said second contact element 190. Electrical circuitry (not shown) generates an electrical signal when said contacts 190 and 191 touch.

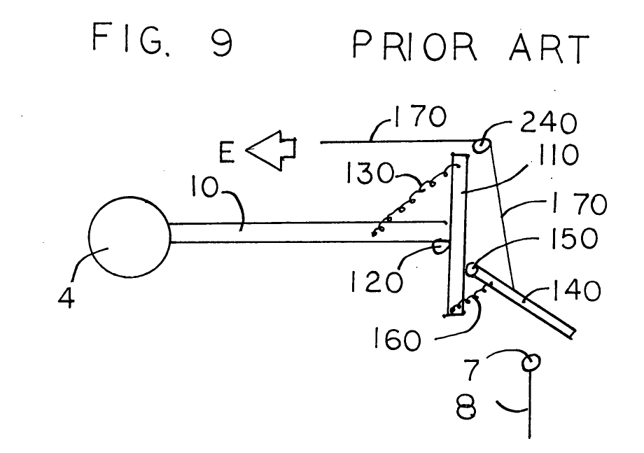

Referring now to the drawing in FIG. 9, there is shown a drawing labeled “prior art.” The reader is referred to FIG. 9 in U.S. Pat. No. 7,334,994 B2 (B. Migler) hereby incorporated by reference, for a complete description of the device. The drawing shows a cross section through a horizontal arm 4 of Migler's vertical axis wind turbine. The figure also shows a horizontal arm of said sail restraint 10, a main vertical member 110, a main rotatable joint 120, a main expansion spring 130, a flapper 140, a rotatable flapper joint 150 and a flapper spring 160. In addition, FIG. 9 shows a cable 170 secured to said flapper 140 through a pulley 240. With the cable drawn in the direction indicated by arrow “E” as shown, the flapper 140 is raised so that the sail 8 and sail frame 7 are able to freely pass under the device.

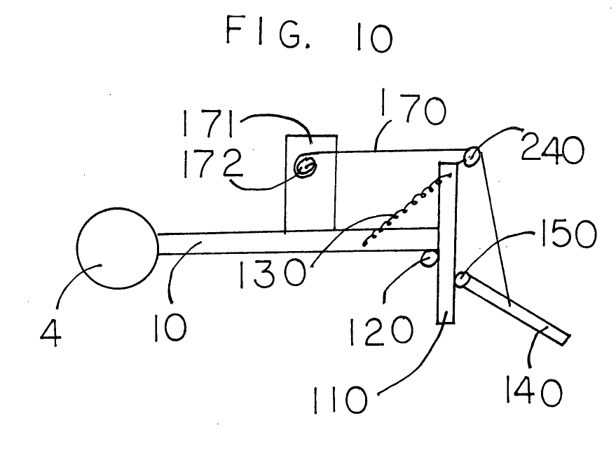

Referring now to the drawing in FIG. 10, there is shown another embodiment of the device shown in FIG. 9. FIG. 10 shows a cross section through a horizontal arm 4 of Migler's vertical axis wind turbine. The figure also shows a horizontal arm of a sail restraint 10, a main vertical member 110, a main rotatable joint 120, a main expansion spring 130, a flapper 140 and a rotatable flapper joint 150. In addition the drawing shows a cable 170 secured to said flapper 140 through a pulley 240. Said cable 170 is wrapped around a take-up reel 172 of a motor 171. When said motor 171 is energized it rotates said take-up reel 172 and draws up said flapper 140, as shown in the drawing.

When a weather report indicates that very strong, potentially damaging winds are approaching, all of the flappers 140 can be pulled up, allowing all the sails to become feathered, thereby resisting wind damage.

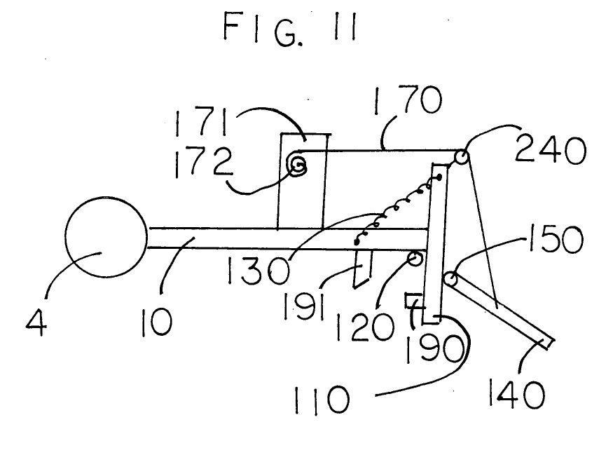

Referring now to the drawing in FIG. 11, there is shown an embodiment of the device shown in FIG. 10 combined with the device shown in FIG. 8. FIG. 11 shows a cross section through a horizontal arm 4 of Migler's vertical axis wind turbine. The figure also shows a horizontal arm of the sail restraint 10, a main vertical member 110, a main rotatable joint 120, a main expansion spring 130, a flapper 140, and a rotatable flapper joint 150. In addition, the drawing shows a cable 170 secured to said flapper 140 through a pulley 240 to a take-up reel 172 of a motor 171. The drawing also shows a first contact element 191 secured to said horizontal arm of said sail restraint 10 and a second contact element 190 secured to said main vertical member 110. FIG. 11 shows said flapper 140 being raised, possibly as a result of a signal from the closing of the contacts 191 and 190 elsewhere on the windmill.

I claim:

1) An energy storage and retrieval device consisting of:
a) a float in water,
b) a motor/dynamo
c) a transmission
d) an electrically controlled axel brake
e) a rotatable axel operated by said motor/dynamo and said transmission and controlled by said axel brake,
f) a cable from said float wound onto said rotatable axel,
g) a float position sensor means to detect the position of said float,
h) an electrical power input connector,
i) an electrical power output connector,
j) a controller, having conventional control circuitry, with an input connection from said float position sensor means, and with input from said electrical power input connector, and with output to said motor/dynamo, and with output to said electrically controlled axel brake, and with output to said electrical power output connector.

2) An energy storage and retrieval device consisting of:
a) a water tank with water,
b) a float in said water,
c) a motor/dynamo
d) a transmission,
e) an electrically controlled axel brake,
f) a rotatable axel operated by said motor/dynamo and said transmission and controlled by said axel brake,
g) a cable from said float wound onto said rotatable axel
h) a float position sensor means to detect the position of said float
i) an electrical power input connection from Migler's vertical axis wind turbine,
j) an electrical output connector,
k) a controller, having conventional control circuitry, with input from said float position sensor means, and input from said electrical power input connection from Migler's vertical axis wind turbine, and with electrical output to said electrically adjustable brake, and with electrical output to said motor/dynamo, and with electrical output to an electrical power output connection.

3) The device of claim 2 having:
a) a water tank with water,
b) a float in said water,
c) a float position sensor means to detect the position of said float,
d) a rotatable axel,
e) a cable from said float wound onto said rotatable axel
f) a motor
g) a dynamo
h) a “storage” transmission driven by said motor which drives said axel,
i) a “release” transmission driven by said axel, which drives said dynamo,
j) an electrically controlled axel brake,
k) electrical power input from Migler's vertical axis wind turbine,
l) an electrical output connector,
m) a controller, having conventional control circuitry, with input from said float position sensor means, and with electrical power input from Migler's vertical axis wind turbine, said controller being able to control said electrically adjustable axel brake, and being able to operate said motor, and being able to direct power from said dynamo to said electrical output connector.

5) Migler's vertical axis wind turbine, having;
a) a sail frame having a rear projecting arm.

6) Migler's vertical axis wind turbine, having:
a) adjacent sail frames connected by a yoke,

7) Migler's vertical axis wind turbine, having:
a) a horizontal arm with separated sail restraints; an inner adjustable sail restraint that restrains a sail frame, and an outer adjustable sail restraint that restrains another sail frame.

8) An adjustable sail restraint for Migler's vertical axis wind turbine having:
a) a first contact element,
b) a second contact element,
whereby a strong gust of wind causes said contact elements to make contact with each other, permitting an electric signal to be generated.

9) The device of claim 9 having:
a) a motor, with a take-up reel,
b) a cable, secured at one end to said take-up reel and secured at the other end to said flapper of the device of claim 9,
whereby operation of said motor draws up said cable, lifting said flapper.

10) The device of claim 9 having:
a) a gust detector, as described in claim 8.
